(19) United States
(12) Patent Application Publication
(10) Pub. No.: US 2023/0327931 A1
(43) Pub. Date: Oct. 12, 2023

(54) TRAVELING PILOTS FOR WIRELESS COMMUNICATION

(71) Applicant: Senscomm Semiconductor Co., Ltd., Suzhou (CN)

(72) Inventors: Yujin NOH, Laguna Hills, CA (US); Seung Hyeok AHN, Laguna Hills, CA (US); Seung Ho CHOO, Suzhou (CN); Young Hwan KANG, Suzhou (CN); Jungchul SHIN, Suzhou (CN); Tan Joong PARK, Seoul (KR); Daehong KIM, Laguna Hills, CA (US); Sung Jin PARK, Seoul (KR)

(21) Appl. No.: 18/187,615

(22) Filed: Mar. 21, 2023

Related U.S. Application Data
(60) Provisional application No. 63/362,736, filed on Apr. 8, 2022.
(60) Provisional application No. 63/370,909, filed on Aug. 9, 2022.
(60) Provisional application No. 63/476,215, filed on Dec. 20, 2022.

(30) Foreign Application Priority Data
Feb. 27, 2023 (CN) 202310179082X

(51) Int. Cl. H04L 27/26; H04L 1/00

(52) U.S. Cl. CPC H04L 27/2613; H04L 1/0069

(57) ABSTRACT

A wireless communication network includes an access point (AP) device and a non-AP device. The AP device transmits a physical layer protocol data unit (PPDU) to the non-AP device. The PPDU includes a data field including a plurality of pilot tones in a plurality symbols. A group of pilot tones is shifted from symbol to symbol within a group of subcarriers during the data field. The non-AP device receives the PPDU and performs channel estimation using the plurality of pilot tones in the data field.

### CROSS REFERENCE TO RELATED APPLICATIONS

This application claims benefit of U.S. Provisional Application No. 63/362,736 filed on Apr. 8, 2022, U.S. Provisional Application No. 63/370,909 filed on Aug. 9, 2022, and U.S. Provisional Application No. 63/476,215 filed on Dec. 20, 2022, in the United States Patent and Trademark Office, and China Patent Application No. 202310179082X filed on Feb. 27, 2023, in the China National Intellectual Property Administration, the entire contents of which are hereby incorporated by reference.

### TECHNICAL FIELD

The disclosure relates generally to wireless communication, and more particularly to, for example, but not limited to, traveling pilots for wireless communication that may improve channel estimation.

### BACKGROUND

Wireless local area network (WLAN) devices are widely deployed in diverse environments to provide various communication services such as video, cloud access, broadcasting and offloading. Some of these environments have a large number of access points (AP) and non-AP stations in geographically limited area. The WLAN technology has evolved toward increasing data rates and continues its growth in various market such as home, enterprise and hotspots over the years since the late 1990s. Recently released standard (IEEE Std 802.11ax-2021) provides improved network performance in the high-dense scenario by adopting OFDMA and MU-MIMO technologies. Those improvements may be made to support environment such as outdoor hotspots, dense residential/office area, and stadiums.

However, there are general needs for devices and methods that improve reliability and data throughput in outdoor situations where devices are moving at medium or high speed. There are also general needs for improved WLAN to support real-time applications or delay-sensitive applications that require strict requirements on the delay and packet loss ratio, such as online gaming, real-time video streaming, virtual reality, and remote-control drone and vehicles.

The description set forth in the background section should not be assumed to be prior art merely because it is set forth in the background section. The background section may describe aspects or embodiments of the present disclosure.

### SUMMARY

One aspect of the present disclosure provides an access point (AP) device for facilitating wireless communication. The AP device comprises a processor configured to generate a physical layer protocol data unit (PPDU) including a first short training field (STF), a first long training field (LTF), a first signal (SIG) field, a repeated first signal (R-SIG) field, a second SIG field, a second STF, one or more second LTFs, and a data field, the data field including a plurality of pilot tones in a plurality symbols, wherein a group of pilot tones is shifted from symbol to symbol within a group of subcarriers during the data field. The AP device comprises a transceiver coupled to the processor. The transceiver is configured to transmit the PPDU to a non-AP device.

In some embodiments, the group of subcarriers is a resource unit (RU).

In some embodiments, the group of subcarriers is a multiple RU (MRU).

In some embodiments, the MRU comprises a plurality of RUs and the group of pilot tones is shifted from symbol to symbol within the entire MRU during the data field.

In some embodiments, the MRU comprises a plurality of RUs, the group of pilot tones is divided into a plurality of sub-groups of pilot tones, and each of the plurality sub-groups of pilot tones is individually shifted from symbol to symbol within a corresponding RU of the plurality of RUs during the data field.

In some embodiments, the second SIG field includes a control information indicating whether the plurality of pilot tones are shifted during the data field.

In some embodiments, the second SIG field includes a control information of a puncturing pattern indicating a punctured subchannel of operating bandwidth.

In some embodiments, the one or more second LTFs include a plurality of pilot tones which have fixed positions.

In some embodiments, the group of subcarriers has a same number of pilot tones in each of the plurality of symbols during the data field.

Another aspect of the present disclosure provides a non-access point (AP) device for facilitating wireless communication. The non-AP device comprises a transceiver configured to receive, from an AP device, a physical layer protocol data unit (PPDU) including a first short training field (STF), a first long training field (LTF), a first signal (SIG) field, a repeated first signal (R-SIG) field, a second SIG field, a second STF, one or more second LTFs, and a data field, the data field including a plurality of pilot tones in a plurality symbols, wherein a group of pilot tones is shifted from symbol to symbol within a group of subcarriers during the data field. The non-AP device comprises a processor coupled to the transceiver and the processor is configured to perform channel estimation using the plurality of pilot tones in the data field.

In some embodiments, the group of subcarriers is a resource unit (RU).

In some embodiments, the group of subcarriers is a multiple RU (MRU).

In some embodiments, the MRU comprises a plurality of RUs and the group of pilot tones is shifted within the entire MRU.

In some embodiments, the MRU comprises a plurality of RUs, the group of pilot tones is divided into a plurality of sub-groups of pilot tones, and each of the plurality of sub-groups of pilot tones is individually shifted from symbol to symbol within a corresponding RU among the plurality of RUs during the data field.

In some embodiments, the second SIG field includes a control information indicating whether the plurality of pilot tones are shifted in the data field.

In some embodiments, the second SIG field includes a control information of a puncturing pattern indicating a punctured subchannel of operating bandwidth.

In some embodiments, the one or more second LTFs include a plurality of pilot tones which have fixed positions, and the processor is further configured to perform channel estimation using the plurality of pilot tones in the one or more second LTFs.

In some embodiments, the group of subcarriers has a same number of pilot tones in each of the plurality of symbols during the data field.

Another aspect of the present disclosure provides a method of a wireless device for facilitating a communication. The method comprises receiving a physical layer protocol data unit (PPDU) including a first short training field (STF), a first long training field (LTF), a first signal (SIG) field, a repeated first signal (R-SIG) field, a second SIG field, a second STF, one or more second LTFs, and a data field, the data field including a plurality of pilot tones in a plurality symbols, wherein a group of pilot tones is shifted from symbol to symbol within a group of subcarriers during the data field, and performing channel estimation using the plurality of pilot tones in the data field.

In some embodiments, the group of subcarriers is a multiple RU (MRU), the MRU comprises a plurality of RUs, and the group of pilot tones is shifted from symbol to symbol within the entire MRU during the data field.

### BRIEF DESCRIPTION OF THE DRAWINGS

FIG. 1 illustrates an example of wireless communication network in accordance with an embodiment.

FIG. 2 illustrates an example of a timing diagram of interframe space (IFS) relationships between wireless devices in accordance with an embodiment.

FIG. 3 illustrates examples of OFDM symbols and OFDMA symbols in accordance with an embodiment.

FIG. 4A illustrates an example of PPDU format in accordance with an embodiment.

FIG. 4B illustrates another example of PPDU format in accordance with an embodiment.

FIG. 5 illustrates an example of traveling pilots in accordance with an embodiment.

FIG. 6 illustrates an example of traveling pilots in 20 MHz MU PPDU in accordance with an embodiment.

FIG. 7 illustrates another example of traveling pilots in accordance with an embodiment.

FIG. 8A and FIG. 8B illustrate examples of RUs in OFDMA 20 MHz PPDU in accordance with an embodiment.

FIG. 9A and FIG. 9B illustrate examples of MRUs in non-OFDMA 80 MHz PPDU in accordance with an embodiment.

FIG. 10 shows an example of operations for facilitating transmission of a downlink PPDU by an AP STA.

FIG. 11 shows an example of operations for facilitating reception of a downlink PPDU by a non-AP STA.

FIG. 12 shows a block diagram illustrating an example of a wireless device in accordance with an embodiment.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purposes of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 wireless standards. However, the described implementations may be implemented in any device, system or network that is capable of transmitting and receiving radio frequency (RF) signals according to one or more of the IEEE 802.11 standards, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

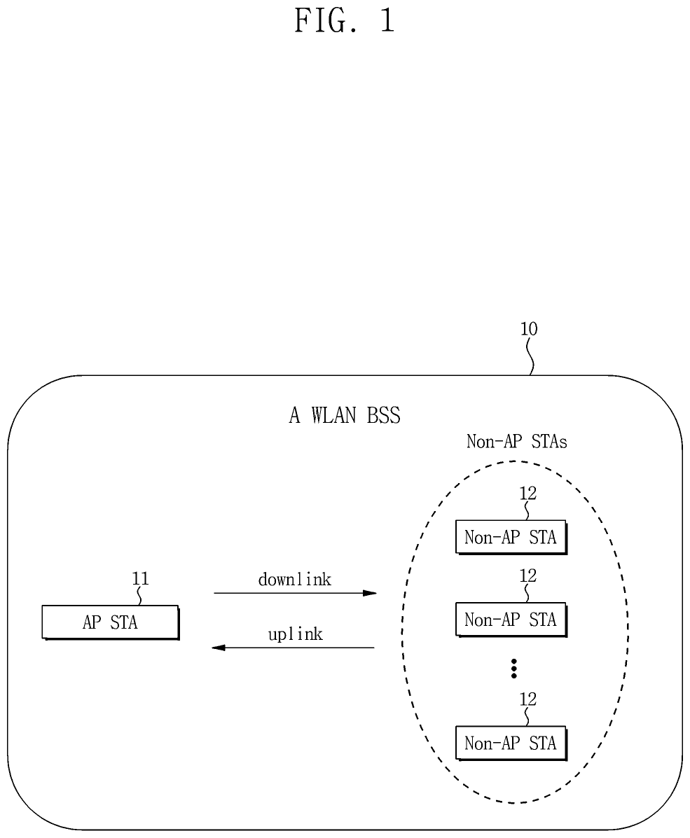

FIG. 1 illustrates an example of wireless communication network in accordance with an embodiment. The wireless communication network includes a Basic Service Set (BSS) 10 of wireless LAN. The BSS 10 provides the basic organizational unit and includes a plurality of wireless devices which may be referred to as stations (STAs). In some implementations, the wireless device may include a plurality of STAs inside. The STA maybe a logical entity that is a singly addressable instance of a medium access control (MAC) and physical layer (PHY) interface to the wireless medium (WM) according to IEEE 802.11 standards. The STA may be an access point (AP) STA and non-AP STA. The AP STA may be an entity that contains one STA and provides access to the distribution system services via the wireless medium for associated STAs. The non-AP STA may be a STA that is not contained within an AP STA. An AP STA and a non-AP STA may be collectively called STAs. For simplicity of description, an AP STA may be referred to as an AP and a non-AP STA may be referred to as a STA or a station. An AP STA may comprise, be implemented as, or be included in a wireless device such as a centralized controller, a base station (BS), a node-B, a base transceiver system (BTS), a site controller, a network adapter, and a router. A non-AP STA may comprise, be implemented as, or be included in a wireless communication device such as a terminal, a wireless transmit/receive unit (WTRU), a user equipment (UE), a mobile station (MS), a mobile terminal, a mobile subscriber unit, a laptop, a smartphone, a battery pack, and a non-mobile computing device.

Referring to FIG. 1, the BSS 10 in the wireless communication network may include an AP STA 11 and a plurality of non-AP STAs 12. The AP STA 11 may transmit information to a single station among the non-AP STAs 12 or may simultaneously transmit information to two or more stations among the non-AP STAs 12. The AP STA 11 may use, for the simultaneous transmission, Downlink (DL) multi-user (MU) transmission scheme such as DL OFDMA (Orthogonal Frequency Division Multiplexing Access) and DL MU-MIMO (Multi-User Multi-Input-Multi-Output). Likewise, each of the non-AP STAs 12 may transmit information to the AP STA singly or may simultaneously transmit information along with other one or more non-AP STAs 12. The non-AP STAs 12 may use, for the simultaneous transmission, Uplink (UL) MU transmission scheme such as UL OFDMA and UL MU-MIMO. In MU-MIMO transmission, a transmitting station may simultaneously transmit information to a plurality of receiving stations using one or more antennas over the same subcarriers. Different spatial streams may be used as the different resources in the MU-MIMO transmission. In OFDMA transmission, a transmitting station may simultaneously transmit information to a plurality of receiving stations over different groups of subcarriers. Different frequency (subcarriers) resources may be used as the different resource in the OFDMA transmission.

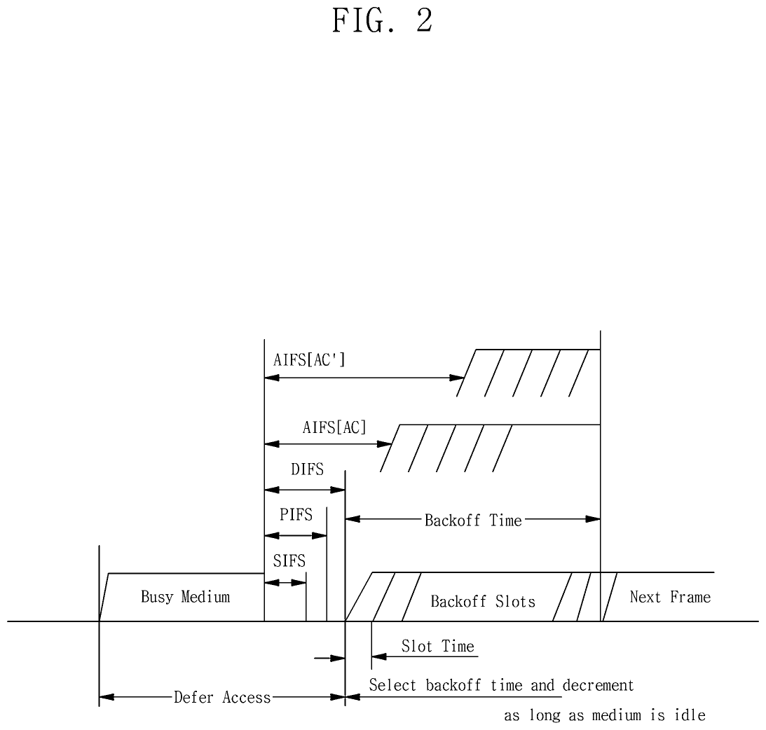

FIG. 2 illustrates an example of a timing diagram of interframe space (IFS) relationships between wireless devices in accordance with an embodiment. FIG. 2 shows a CSMA (carrier sense multiple access)/CA (collision avoidance) based frame transmission procedure for avoiding collision between frames in a channel. Various frames such as a data frame, a control frame, or a management frame may be exchanged between wireless devices.

The data frame may be used for transmission of data forwarded to a higher layer. In FIG. 2, an access to the medium (or the channel) by wireless devices are deferred while the medium is busy until an IFS duration has elapsed. For example, the wireless device may transmit the data frame after performing a period of backoff when a Distributed Coordination Function (DCF) IFS (DIFS) has elapsed during which the medium is idle. The management frame may be used for exchanging management information which is not forwarded to the higher layer. The management frame includes a beacon frame, an association request/response frame, disassociation frame, reassociation request/response frame, a probe request/response frame, and an authentication request/response frame and action frame. The control frame may be used for controlling access to the medium. The control frame includes a request to send (RTS) frame, a clear to send (CTS) frame, and an acknowledgement (ACK) frame, BlockAck request/response frame, NDP (Null Data PPDU) Announcement frame. If the control frame is not a response frame of other frame, the wireless device may transmit the control frame after performing backoff when the DIFS has elapsed during which the medium is idle. However, if the control frame is a response frame of other frame, the wireless device may transmit the control frame without performing backoff when a short IFS (SIFS) has elapsed. Further, a QoS (Quality of Service) STA may transmit the frame after performing backoff operation when an arbitration IFS (AIFS) for access category (AC) (i.e., AIFS [AC]) has elapsed. In some embodiments, a point coordination function (PCF) enabled AP STA may transmit the frame after performing backoff when a PCF IFS (PIFS) has elapsed. The PIFS duration may be less than the DIFS duration, but greater than the SIFS duration.

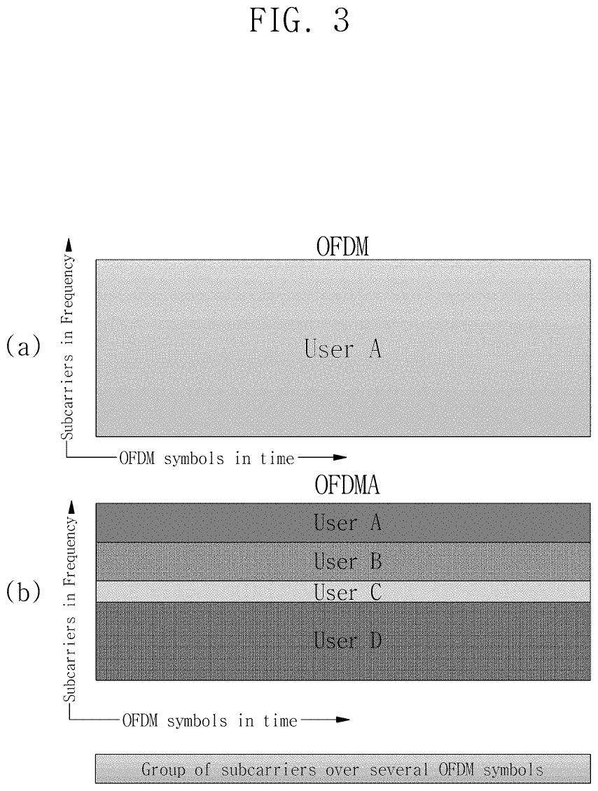

FIG. 3 illustrates examples of OFDM symbols and OFDMA symbols in accordance with an embodiment. In FIGS. 3(a) and 3(b), OFDM symbols are illustrated along the time dimension and subcarriers are illustrated along the frequency dimension.

The OFDMA was introduced in IEEE 802.11ax standard which is also known as High Efficiency (HE) WLAN. The OFDMA will be also used in next amendments to IEEE 802.11 standard such as Extreme High Throughput (EHT) WLAN. One or more STAs may be allowed to use one or more resource units (RUs) throughout operating bandwidth to transmit data at the same time. The RU may be a group of subcarriers as an allocation for subcarriers for transmission. In some aspects, non-AP STAs may be associated or non-associated with AP STA when transmitting response frames simultaneously in assigned RUs after a specific period of time such as SIFS. The SIFS may be the time from the end of the last symbol, or signal extension if present, of the previous frame to the beginning of the first symbol of the preamble of the subsequent frame.

The OFDMA is an OFDM-based multiple access scheme where different groups of subcarriers are allocated to different users, which allows simultaneous transmission to one or more users with high accurate synchronization for frequency orthogonality. The OFDMA allows users to are allocated to different groups of subcarriers in each PPDU (physical layer protocol data unit). An OFDM symbol in the OFDMA includes a number of subcarriers depending on the PPDU bandwidth. The difference between OFDM and OFDMA is illustrated in FIG. 3. As shown in FIG. 3(a), the OFDM symbol includes one single user (User A), while the OFDMA symbol includes a plurality of users (User A, User B, User C, User D) and each user is assigned and allocated into different group of subcarriers as shown in FIG. 3(b).

In case of UL MU transmission, the AP STA may want to control the medium by using more scheduled access mechanism which allows AP STAs and non-AP STAs to use OFDMA and MU-MIMO more frequently. PPDUs in UL MU transmission may be sent by non-AP STAs as a response to a trigger frame sent by the AP STA. The trigger frame may have information for receiving STAs and assign a single or multiple RU to the receiving STAs. It allows non-AP STAs to transmit OFDMA-based frame in the form of trigger-based (TB) PPDU (e.g., HE TB PPDU or EHT TB PPDU) where an operating bandwidth is segmented into a plurality of RUs and all RU as responses to the trigger frame. For simplicity of description, a single RU and a multiple RU (MRU) which are allocated into a non-AP STA may be collectively referred to as an RU. In some embodiments, the MRU may indicate that two RUs are combined.

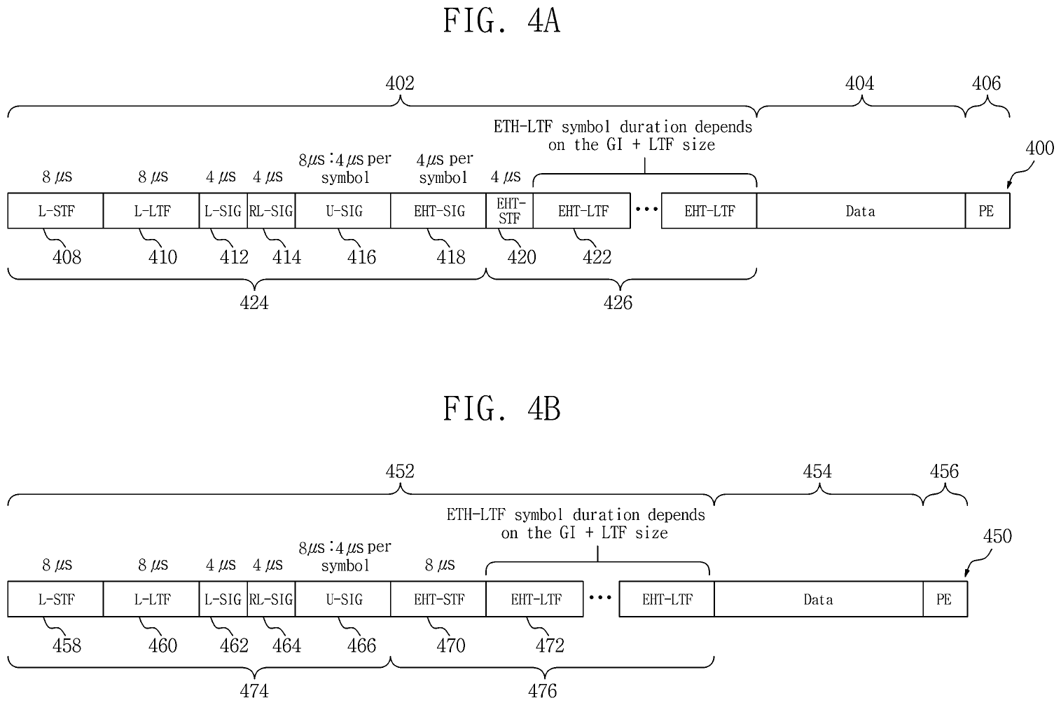

FIG. 4A illustrates an example of PPDU format in accordance with an embodiment. The PPDU may be used for SU and MU transmission. The PPDU may be used as EHT MU PPDU in accordance with IEEE 802.11be or may be used as a PPDU in accordance with any future amendments to the IEEE 802.11 standard.

Referring to FIG. 4A, the EHT MU PPDU 400 may include an EHT preamble 402 (may be referred to as a preamble or PHY preamble), a data field 404, and a packet extension (PE) field 406. The EHT preamble 402 may include pre-EHT modulated fields 424 and EHT modulated fields 426. The pre-EHT modulated fields 424 may include a legacy short training field (L-STF) 408, a legacy long training field (L-LTF) 410, a legacy signal (L-SIG) field 412, a repeated legacy signal (RL-SIG) field 414, a universal signal (U-SIG) field 416 and a EHT signal (EHT-SIG) field 418. The EHT modulated fields 426 may include an EHT short training field (EHT-STF) 420 and one or more EHT long training fields (EHT-LTFs) 422.

The L-STF 408 may be utilized for packet detection, automatic gain control (AGC) and coarse frequency-offset correction. The L-LTF 410 may be utilized for channel estimation, fine frequency-offset correction, and symbol timing. The L-SIG field 412 may provide information for communication such as data rate, length related to the EHT PPDU 400. The RL-SIG field 414 may be a repeat of the L-SIG field 412 and may be used to differentiate an EHT PPDU from other PPDUs conforming to other IEEE 802.11 standards such as IEEE 802.11a/n/ac. The U-SIG field 416 may provide information necessary for receiving STAs to interpret the EHT MU PPDU 400. The EHT-SIG 418 may provide additional information to the U-SIG field 416 for receiving STAs to interpret the EHT MU PPDU 400. For simplicity of description, the U-SIG field 416, the EHT-SIG field 418 or both may be referred to herein as the SIG field. EHT-LTFs 422 may enable receiving STAs to estimate the MIMO channel between a set of constellation mapper output and the receive chains. The data field 404 may carry one or more PHY service data units (PSDUs). The PE field 406 may provide additional receive processing time at the end of the EHT MU PPDU.

FIG. 4B illustrates another example of PPDU format in accordance with an embodiment. The PPDU may be used for SU and MU transmission. The PPDU may be used as EHT TB (Trigger-based) PPDU 450 in accordance with IEEE 802.11be or may be used as a PPDU conforming to any of future amendments to the IEEE 802.11 standard. In some embodiments, the EHT TB PPDU 450 is used for transmission by non-AP STA that is a response to a triggering frame from an AP STA.

As shown in FIG. 4B, the EHT TB PPDU 450 may include an EHT preamble 452 (may be referred to as a preamble or PHY preamble), a data field 454, and a packet extension (PE) field 456. The EHT preamble 452 may include pre-EHT modulated fields 474 and EHT modulated fields 476. The pre-EHT modulated fields 474 may include a L-STF 458, a L-LTF 460, a L-SIG field 462, a RL-SIG field 464, a U-SIG field 466. The EHT modulated fields 476 may include an EHT-STF 470 and one or more EHT-LTFs 472. Unlikely the EHT MU PPDU 400, the EHT-SIG 418 is not present in the EHT TB PPDU 450. Instead, the duration (8 us) of the EHT-STF 470 of the EHT TB PPDU 450 is twice the duration (4 us) of the EHT-STF 420 of the EHT MU PPDU 400. Detailed description for each of other fields in the EHT TB PPDU 450 will be omitted because the above description for each field in the EHT MU PPDU 400 may be applied to each of the EHT TB PPDU 450.

In WLAN system, the pilots are generally included in LTF symbols (e.g., L-LTF, EHT LTF in FIGS. 4A and 4B) and data symbols (e.g., data field in FIGS. 4A and 4B) of a PPDU. The pilots in data symbols may generally be used for tracking frequency offset for channel estimation. As pilot tones are transmitted with a known sequence, it may be used for receiving STAs to determine the difference between an ideal signal and the actual received signal. Further, the pilots in data symbols may be used for tracking changes in the channel coefficient while the STA receives the PPDU.

An example of pilot locations in EHT WLAN conforming to IEEE 802.11be standard are provided in the following Table 1. Table 1 shows one of pilot locations for 242-tone RU where the pilot subcarriers are present at subcarriers k∈K_{R242i}, where K_{R242i} is given by the i-th pilot index set in the row of given PPDU bandwidth. For example, for 80 MHz PPDU bandwidth, there are four 242-tone RUs and 8 pilots are respectively present in each 242-tone RU. For 160 MHz PPDU bandwidth, there are eight 242-tone RUs and 8 pilots are respectively present in each 242-tone RU. For 32 MHz PPDU bandwidth, there are sixteen 242-tone RUs and 8 pilots are respectively present in each 242-tone RU. In EHT WLAN system, pilot subcarriers are present in both the data symbol and EHT-LTF symbols, and pilot subcarrier locations are fixed. Further, pilot subcarrier locations in the EHT-LTF are the same as pilot subcarrier locations in the data symbols.

TABLE 1

| PPDU | |
|---|---|
| bandwidth | K_{R242i} |
| 80 MHz, | {−494, −468, −426, −400, −360, −334, −292, −266}, |
| i = 1:4 | {−246, −220, −178, −152, −112, −86, −44, −18}, |
| | {18, 44, 86, 112, 152, 178, 220, 246}, |
| | {266, 292, 334, 360, 400, 426, 468, 494} |
| 160 MHz, | {pilot subcarrier indices in 80 MHz − 512, pilot |
| i = 1:8 | subcarrier indices in 80 MHz + 512} |
| 320 MHz, | {pilot subcarrier indices in 160 MHz − 1024, pilot |
| i = 1:16 | subcarrier indices in 160 MHz + 1024} |

As the pilot locations are fixed in both data symbols and EHT-LTF symbols, the pilots may not provide accurate channel estimation information when receiving STAs are located in outdoor situation and moving at medium or high speed. The fixed pilots are not enough to track channel status correctly over the operating bandwidth because channel condition may constantly change during the transmission. Further, when the receiving STA is moving, the Doppler effect may substantially alter the channel condition. The present disclosure provides various embodiments to resolve these problems.

In an embodiment, traveling pilots may be included in the data field of the PPDU. the pilot subcarrier locations may be shifted among subcarriers from symbol to symbol in the data field of the PPDU. Thereby, all or at least most subcarriers may be covered to estimate channel coefficient (i.e., channel status). It enables a continuous update on the initial channel estimation while the STA receives the PPDU. In some implementations, the pilot subcarrier locations may be shifted within a group of symbols in the data field. For example, a first pilot tone pattern may be applied to the first three symbols and a second pilot tone pattern may be applied to the following three symbols. It might help to reduce implementation complexity compared to the case the pilot locations changes per each symbol in entire data field of the PPDU. Hereinafter, when some embodiments describe that pilot subcarrier locations are shifted from symbol to symbol, it should be understood that it is also applicable to the case that the pilot subcarrier locations are shifted within a group of symbols. The existence of the traveling pilots may be explicitly indicated or signaled in a control information in the SIG field (U-SIG or EHT-SIG in FIGS. 4A and 4B) or may be implicitly indicated in various ways such as using MCS (Modulation Coding Scheme) value or number of spatial streams (e.g., N_{SS}).

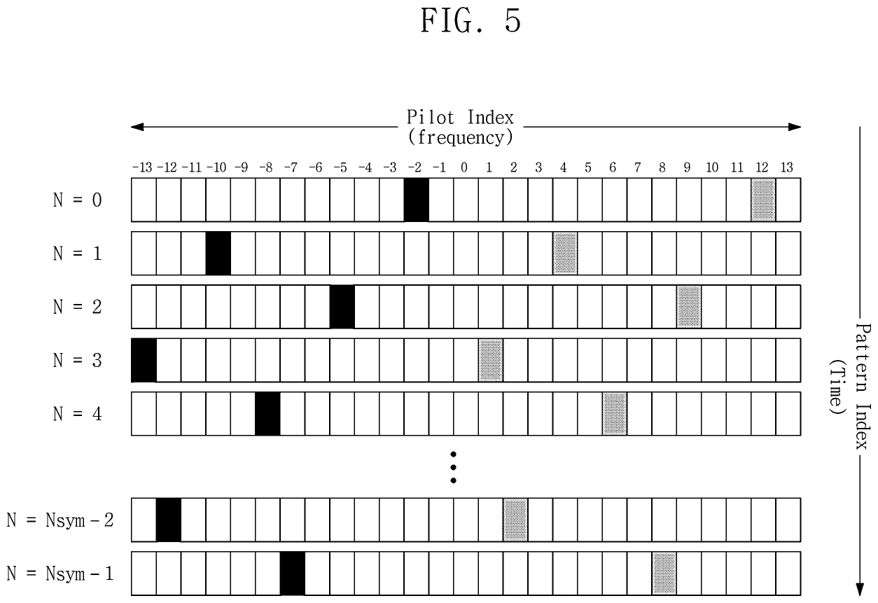

FIG. 5 illustrates an example of traveling pilots in accordance with an embodiment. In FIG. 5, subcarriers (tones) are illustrated along the frequency dimension and OFDM symbols n (n=0, 1, 2, . . . , N_{SYM}−1) are illustrated along the time dimension.

FIG. 5 shows an example of 26-tone RU. Each symbol includes 26 tones (or subcarriers) except for a DC (direct current) tone which is associated with zero index. Each symbol includes two pilots, and the location of pilots varies from symbol to symbol over entire bandwidth. A first pilot is shifted among subcarriers associated with index −13 to −1 per each symbol along the time dimension and a second pilot is shifted among subcarriers associated with index 1 to 13 per each symbol. As shown FIG. 5, pilot tones are located on subcarriers −2 and 12 on symbol 0 and the locations of pilot tones are shifted into subcarrier −10 and 4 on symbol 1. The pilot tone locations are shifted over all symbols as illustrated in FIG. 5. As result, the pilot position may cover all or most tones of OFDM symbol to provide more accurate information for the receiving STA to track channel status for channel estimation even in outdoor situation where the STA is moving.

In some aspects, various RUs may be defined for DL and UL transmission to implement OFDMA such as 26-tone RU, 52-tone RU, 106-tone RU, 242-tone RU, 484-tone RU, 996-tone RU and 2×996-tone RU. The EHT WLAN conforming IEEE 802.11be standard supports the usage of multiple resource unit (MRU) in an EHT PPDU to be assigned to a single receiving STA. An MRU includes combinations of multiple RUs among 26-tone RU, 52-tone RU, 106-tone RU, 242-tone RU, 484-tone RU, 996-tone RU, and 2×996-tone RU. RUs that are the same size as or larger than 242-tone RUs are referred to as large size RUs, and RUs that are smaller than 242-tone RUs are referred to as small size RUs. Small size RUs can only be combined with small size RUs to form small size MRUs. Large size RUs can only be combined with large size to form large size MRUs. The small size MRUs for DL and UL OFDMA transmissions may be 52+26-tone MRU or 106+26-tone MRU. The large size MRUs for DL and UL non-OFDMA transmissions may be 484+242-tone MRU, 996+484-tone MRU, 996+484+242-tone MRU, 2×996+484-tone MRU, 3×996-tone MRU, and 3×996+484-tone MRU.

Each RU in data field is designed to have pilot. If the pilots travel across the RU from one symbol to another symbol over the entire operating bandwidth, no or less pilots than fixed pilot design, in some cases, may be allocated to one or more RUs and it may cause that the receiving STA is not able to perform channel estimation correctly for the RU with no or less pilots. On the other hand, more pilots than fixed pilot design may be allocated to some RUs which will degrade data throughput for the RUs. As described, different number of pilot tones may be allocated in RUs depending on how the pilots travel among the subcarriers from one symbol to another symbol.

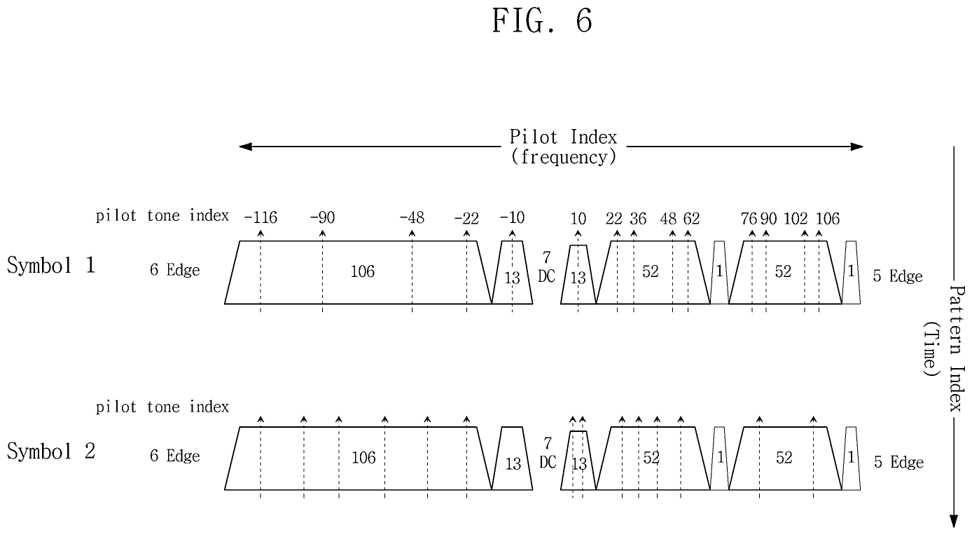

FIG. 6 illustrates an example of traveling pilots in 20 MHz MU PPDU in accordance with an embodiment. This example may be usable in IEEE 802.11be standard and any future amendments to the IEEE 802.11 standard.

As shown in FIG. 6, RUs are illustrated along the frequency dimension and OFDM symbols are illustrated along the time dimension. For simplicity of description, two OFDM symbols are illustrated. The 20 MHz bandwidth includes 4 RUs such as a 106-tone RU, a 26-tone RU, and two 52-tone RUs. The 26-tone RU is allocated in the center and split into two 12-tone by seven (7) DC tones. The 20 MHz bandwidth additionally includes two null subcarriers that have zero energy, each of which is allocated in each side of the right 52-tone RU. Also, there are 5 guard tones on the right edge of the 20 MHz bandwidth and 6 guard tones on left edge of the bandwidth.

As shown on symbol 1 of in FIG. 6, four (4) pilot subcarriers −116, −90, −48 and −22 are allocated on the 106-tone RU, two (2) pilot subcarriers −10 and 10 are allocated on the 26-tone RU, four (4) pilot subcarriers 22, 36, 48, and 62 are allocated on the left 52-tone RU, and four (4) pilot subcarriers 76, 90, 102, 106 are allocated on the right 52-tone RU. Then, the pilot tone locations may be shifted on symbol 2 as shown in FIG. 6. In the example of FIG. 6, the pilot tone locations on symbol 1 are the same as the fixed pilot tone locations conforming to IEEE 802.11be standard.

On the other hand, as shown on symbol 2 of FIG. 6, six (6) pilot subcarriers are allocated on the 106-tone RU, two (2) pilot subcarriers are allocated on right 13-tone of the 26-tone RU, four (4) pilot subcarriers are allocated on the left 52-tone RU, and two (2) pilot subcarriers are allocated on the right 52-tone RU.

As shown in FIG. 6, some RUs (i.e., the left 13-tone of the 26-tone RU and the right 52-tone RU on symbol 2) includes fewer pilot tones (or no pilot tones) than the fixed pilot model on symbol 1 while some other RUs (i.e., the 106-tone RU and the right 13-tone of the 26-tone RU) include more pilot tones than symbol 1. As described above, the less or more pilots on RU than the fixed pilot model may cause degradation in channel estimation and data throughput for the entire bandwidth.

In an embodiment, the pilot positions may be allocated based on the RU size using the modulo operation of the following Equation 1.

m(n)=n mod N_{PP,RU} Equation (1)

where m is the traveling pilot pattern index, n is symbol index, and N_{PP,RU} is the traveling pilot pattern period which may be different depending on the RU size. For example, N_{PP,RU} may be determined based on the number of pilot subcarrier (N_{SP}) on each RU as specified in the following Table 2 as below:
N_{PP,26-tone RU}=13
N_{PP,52-tone RU}=13 (or 14)
N_{PP,106-tone RU}=14
N_{PP,242-tone RU}=32
N_{PP,484-tone RU}=32
N_{PP,996-tone RU}=32
N_{PP,2×996-tone RU}=32
N_{PP,3×996-tone RU}=32

TABLE 2

| | 26 - | 52- | 106- | 242- | 484- | 996- | 2 × 996- | 4 × 996- |
|---|---|---|---|---|---|---|---|---|
| | tone | tone | tone | tone | tone | tone | tone | tone |
| Parameter | RU | RU | RU | RU | RU | RU | RU | RU |
| N_{SP} | 2 | 4 | 4 | 8 | 16 | 16 | 32 | 64 |

| | | | | | 996 + 484 + | 2 × 996 + | | 3 × 996 + |
|---|---|---|---|---|---|---|---|---|
| | 52 + 26- | 106 + 26- | 484 + 242- | 996 + 484- | 242- | 484- | 3 × 996- | 484- |
| | tone | tone | tone | tone | tone | tone | tone | tone |
| Parameter | MRU | MRU | MRU | MRU | MRU | MRU | MRU | MRU |
| N_{SP} | 6 | 6 | 24 | 32 | 40 | 48 | 48 | 64 |

Table 2 shows, in particular, an example of the number of pilot subcarrier (N_{SP}) on MRUs including 52+26-tone MRU, 106+26-tone MRU, 484+242-tone MRU, 996+484-tone MRU, 996+484+242-tone MRU, 2×996+484-tone MRU, 3×996-tone MRU, and 3×996+484-tone MRU

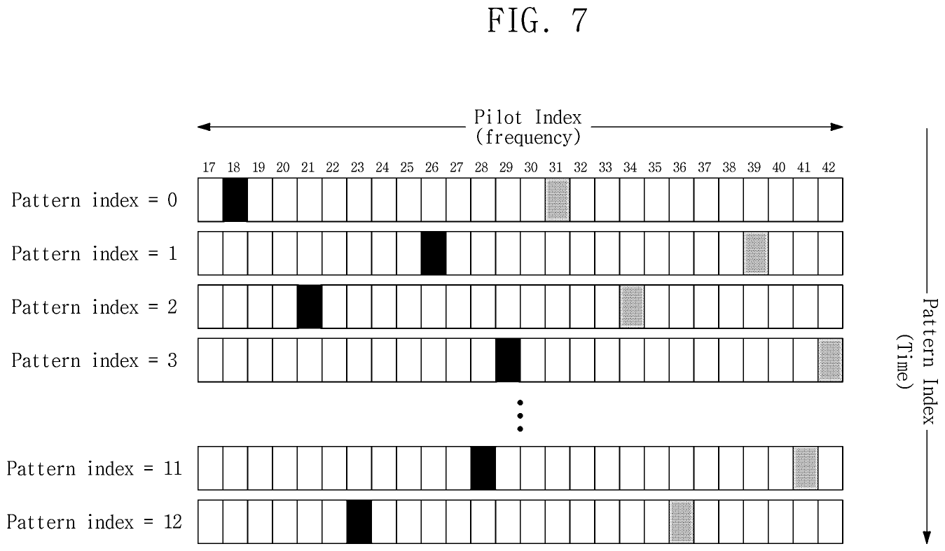

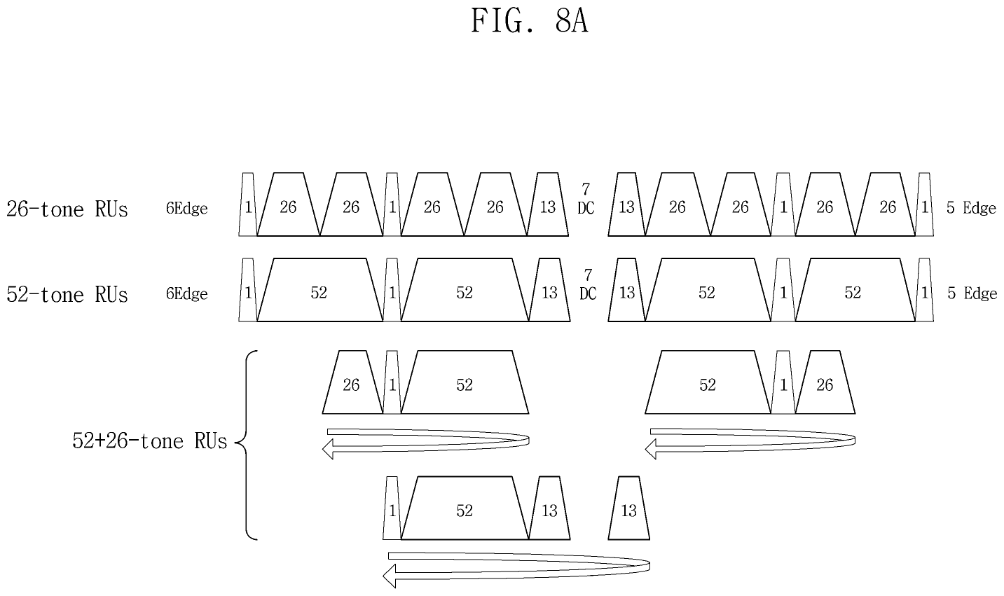

Another example for traveling pattern for 26-tone RU is specified in the following table 3 and FIG. 7. FIG. 7 illustrates another example of traveling pilots in accordance with an embodiment. As shown in the example, subcarriers (tones) are illustrated along the frequency dimension and OFDM symbols are illustrated along the time dimension. Each symbol includes two pilot subcarriers which travels among the subcarriers within the symbol. FIG. 7 shows an example of 26-tone RU in 20 MHz PPDU conforming to IEEE 802.11be standard and the RU includes 26 subcarriers having index 17 to 42.

Referring to FIG. 7 and the Table 3, the traveling pilot pattern period (the distance between two pilots) is 13. The order of the traveling pilot pattern may be altered according to various embodiments without departing from the scope of this disclosure. The fixed pilot location for one of 26-tone RUs in 20 MHz PPDU conforming to IEEE 802.11be standard may be subcarriers 22 and 36. As shown in FIG. 7 and the Table 3, the pilot tone locations change per traveling pilot pattern index (or pattern index). This pattern illustrated in FIG. 7 and the Table 3 may be applied to the entire 26-tone RUs of PPDU.

TABLE 3

| | Pattern index | | | | | | | | | | | | |
|---|---|---|---|---|---|---|---|---|---|---|---|---|---|
| Pilot index | 0 | 1 | 2 | 3 | 4 | 5 | 6 | 7 | 8 | 9 | 10 | 11 | 12 |
| 0 | 18 | 26 | 21 | 29 | 24 | 19 | 27 | 22 | 17 | 25 | 20 | 28 | 23 |
| 1 | 31 | 39 | 34 | 42 | 37 | 32 | 40 | 35 | 30 | 38 | 33 | 41 | 36 |

In another embodiment, the pilot positions may be determined based on the following Equation 2.

k_{PP_{l,n}}=k_{Fix_l}+f(n)mod N_{PP,RU}+L_{l,m}. Equation (2)

where k_{Fix_l} is the l-th pilot in the OFDM symbol which is present in a fixed position regardless of the OFDM symbol n. f(n) is a specific function for n-th OFDM symbol. L_{l,m} is a value for shift for l-th pilot in the m-th pilot pattern comparing to the fixed pilot position. m is calculated by the Equation 1. The f(n) may be specifically defined according to various embodiments.

In Table 2, each of 52+26-tone MRU and 106+26-tone MRU have the same number of pilot subcarriers (i.e., six) within its MRU. Considering that the 106+26-tone MRU is larger than the 52+26-tone MRU, the 52+26-tone MRU may have more pilot subcarriers than it is necessary. To increase data throughput for 52+26-tone MRU, fewer pilot tones such as only 4 pilot tones, could be used for traveling pilot pattern. For example, when a small size MRU is assigned to a receiving STA in high doppler circumstances such as the STA is moving at medium-high speed, the number of pilot tones for 52-tone RU (e.g., 4 pilot tones) or 106-tone RU (e.g., 4 pilot tones) may be used for traveling pilot for 52+26-tone MRU or 106+26-tone MRU. This may be also applied to a large size MRU. In this embodiment, the number of pilot tones for MRU may be smaller than the number of pilot tones for the MRU specified in the Table 2 when the traveling pilot pattern is applied according to embodiments of this disclosure.

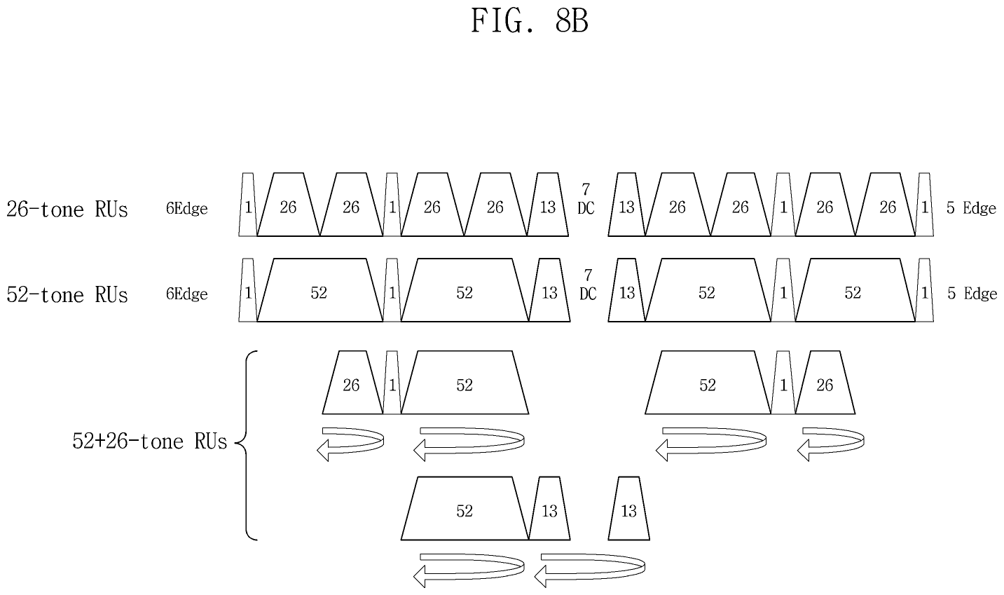

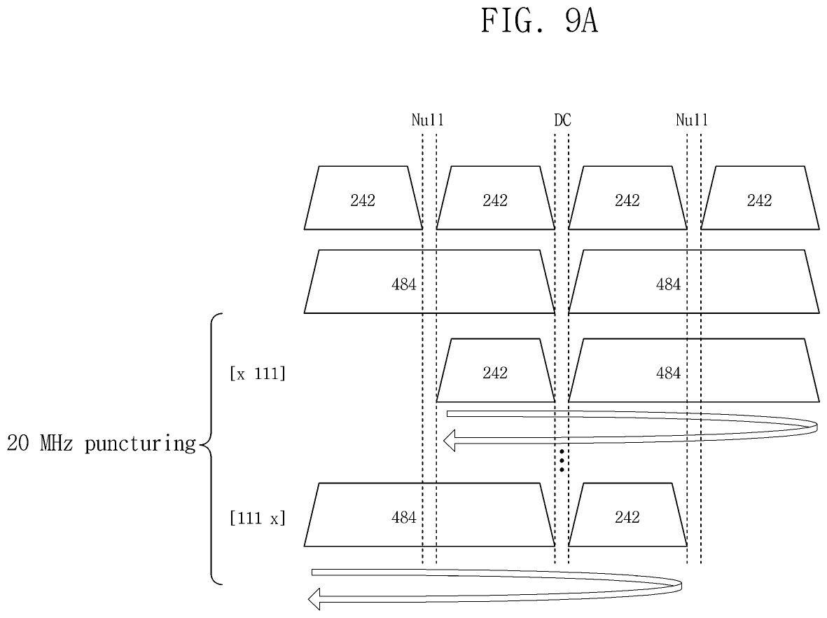

FIG. 8A and FIG. 8B illustrate examples of RUs in OFDMA 20 Hz PPDU in accordance with an embodiment. The example may be used as an OFDMA 20 Hz EHT PPDU for DL and UL transmission conforming IEEE 802.11be standard and any future amendments to the IEEE 802.11 standard.

A first row shows a resource allocation of the 20 MHz bandwidth into multiple 26-tone RUs. The 20 MHz bandwidth may be allocated into nine (9) 26-tone RUs. Each non-center RU includes 26 tones and a center 26-tone RU includes 26 tones. The center 26-tone RU is split into two (2) 13-tones by 7 DC tones. Two (2) null subcarriers may be allocated on each side of the 20 MHz bandwidth and one (1) null subcarrier may be allocated after two 26-tone RUs from the left side and one (1) null subcarrier may be allocated after the two 26-tone RUs from the right side.

A second row shows a resource allocation of the 20 MHz bandwidth into multiple 52-tone RUs. The 20 MHz bandwidth may be allocated into four (4) 52-tone RUs and one (1) center 26-tone RU. The center 26-tone RU is spilt into two (2) 13-tones by 7 DC tones. Two (2) null subcarriers may be allocated on each side of the 20 MHz bandwidth and one (1) null subcarrier may be allocated after the first 52-tone RU from the left side and one (1) null subcarrier may be allocated after the first 52-tone RU from the right side.

A third row shows an example of 52+26-tone MRUs. Two (2) 52+26-tone MRUs may be allocated. The left 52+26-tone MRU may include one (1) 26-tone RU in the left and one (1) 52-tone RU in the right. One (1) null subcarrier may be allocated between the 26-tone RU and the 52-tone RU. The right 52+26-tone MRU may include one (1) 52-tone RU in the left and one (1) 26-tone RU in the right. One (1) null subcarrier may be respectively allocated between the 26-tone RU and the 52-tone RU. The location of the null subcarrier in the left 52+26-tone MRU may be aligned with the null subcarriers which are allocated in the second null subcarriers from the left side in the first and the second row. The location of the null subcarrier in the right 52+26-tone MRU may be aligned with the null subcarrier which are allocated in the second null subcarriers from the right side in the first and the second row.

A fourth row shows another example of 52+26-tone MRU. The 52+26-tone MRU includes one (1) 52-tone RU in the left and one (1) center 26-tone in the right which is split into two (2) 13-tone RU by 7 DC tones. A null subcarrier may be allocated before the 52-tone RU and the location of the null subcarrier may be aligned with the null subcarriers which are allocated in the second null subcarriers from the left in the first and the second row.

In an embodiment, the modulo operation given in Equation 1 may be differently applied to MRU. For example, the modulo operation may be applied based on the entire MRU (small or large size MRU) which includes two or more RUs. Referring to FIG. 8A, the modulo operation given in Equation 1 may be applied to entire 52+26-tone MRU illustrated in the third and fourth row. That is, the modulo operation may be applied to the entire 52+26-tone MRU regardless of the size of each RU included within the 52+26-tone MRU. Thereby, the pilot position shift would be limited within the entire 52+26-tone MRU.

In another embedment, the modulo operation given Equation 1 may be applied to each RU of the MRU (small or large size MRU). Referring to FIG. 8B, the modulo operation given in Equation 1 may be applied to each RU (i.e., 26-tone RU and 52-tone RU) of the MRU. The 52+26 tone MRU includes 52-tone RU and 26-tone RU and the modulo operation is individually applied to the 52-tone RU and 26-tone. Accordingly, the same modulo operation as described above using Equation 1 and the Table 2 may be applied in this embodiment.

The modulo operation to allocate traveling pilot position described above using Equation 1 may be differently applied to non-OFDMA PPDU which are described below.

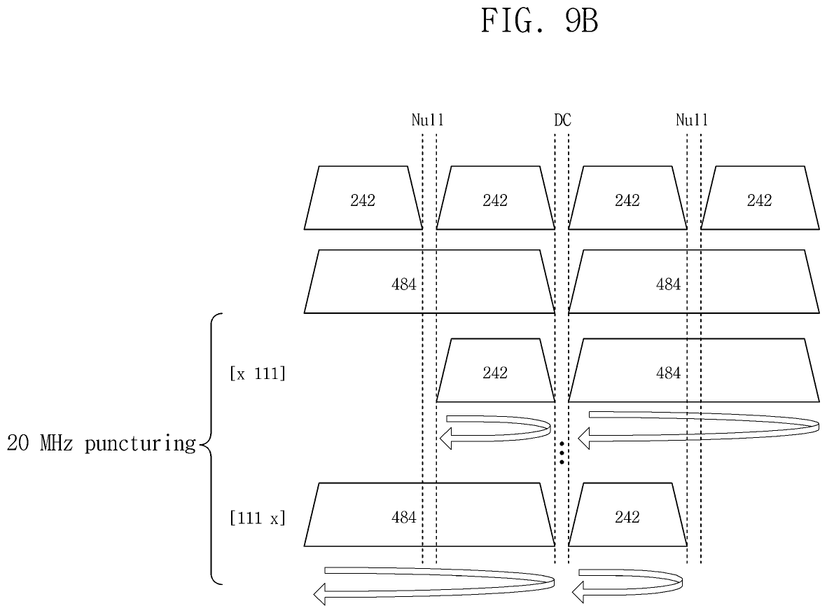

FIG. 9A and FIG. 9B illustrate examples of MRUs in non-OFDMA 80 MHz PPDU in accordance with an embodiment. The example of MRUs may be used in a non-OFDMA 80 MHz EHT PPDU for DL and UL transmission conforming IEEE 802.11be standard and any future amendments to the IEEE 802.11 standard.

A first row shows a resource allocation of the 80 MHz bandwidth into four (4) 242-tone RUs. Null subcarriers may be respectively allocated between left two 242-tone RUs and between right two 242-tone RUs. DC tones may be allocated in the center of the bandwidth.

A second row shows a resource allocation of the 80 MHz bandwidth into two (2) 484-tone RUs. DC tones may be allocated in the center of the bandwidth.

A third row and the fourth row show 484+242-tone MRUs when a 20 MHz subchannel is punctured in a non-OFDMA 80 Hz bandwidth. As shown in FIGS. 9A and 9B, the leftmost 20 MHz subchannel is punctured in the third row and the rightmost 20 MHz subchannel is punctured in the fourth row. The puncturing pattern may be indicated in SIG field of the PPDU. For example, U-SIG field 416 or 466 in FIGS. 4A and 4B may include puncturing channel information.

Table 4, as shown below, provides examples of puncturing channel information field included in the SIG field. In the puncturing pattern shown in Table 4, a ‘1’ denotes a non-punctured subchannel and an ‘x’ denotes a punctured subchannel. The puncturing granularity for 20 MHz, 40 MHz, 80 MHz, and 160 MHz PPDU bandwidth is 20 MHz, and the puncturing granularity for 320 MHz PPDU bandwidth is 40 MHz. Parameter from left to right refers to 20 MHz or 40 MHz subchannels in the order of increasing frequency. For example, the 484+242-tone MRU illustrated in the third row of FIGS. 9A and 9B has [x 1 1 1] pattern and the 484+242-tone MRU illustrated in the fourth row of FIGS. 9A and 9B has [1 1 1 x] pattern. Table 4

TABLE 4

| PPDU | | | | |
|---|---|---|---|---|
| band- | | | Puncturing pattern | Field |
| width | | Cases | (RU or MRU Index) | value |
| 20 | MHz | No | [1] | 0 |
| | | puncturing | (242-tone RU 1) | |
| 40 | MHz | No | [1 1] | 0 |
| | | puncturing | (484-tone RU 1) | |
| 80 | MHz | No | [1 1 1 1] | 0 |
| | | puncturing | (996-tone RU 1) | |
| | | 20 MHz | [x 1 1 1] | 1 |
| | | puncturing | (484 + 242-tone MRU 1) | |
| | | | [1 x 1 1] | 2 |
| | | | (484+242-tone MRU 2) | |
| | | | [1 1 x 1] | 3 |
| | | | (484 + 242-tone MRU 3) | |
| | | | [1 1 1 x] | 4 |
| | | | (484 + 242-tone MRU 4) | |
| 160 | MHz | No | [1 1 1 1 1 1 1 1] | 0 |
| | | puncturing | (2 times; 996-tone RU 1) | |
| | | 20 MHz | [x 1 1 1 1 1 1 1] | 1 |
| | | puncturing | (996 + 484 + 242-tone MRU 1) | |
| | | | [1 x 1 1 1 1 1 1] | 2 |
| | | | (996 + 484 + 242-tone MRU 2) | |
| | | | [1 1 x 1 1 1 1 1] | 3 |
| | | | (996 + 484 + 242-tone MRU 3) | |
| | | | [1 1 1 x 1 1 1 1] | 4 |
| | | | (996 + 484 + 242-tone MRU 4) | |
| | | | [1 1 1 1 x 1 1 1] | 5 |
| | | | (996 + 484 + 242-tone MRU 5) | |
| | | | [1 1 1 1 1 x 1 1] | 6 |
| | | | (996 + 484 + 242-tone MRU 6) | |
| | | | [1 1 1 1 1 1 x 1] | 7 |
| | | | (996 + 484 + 242-tone MRU 7) | |
| | | | [1 1 1 1 1 1 1 x] | 8 |
| | | | (996 + 484 + 242-tone MRU 8) | |
| | | 40 MHz | [x x 1 1 1 1 1 1] | 9 |
| | | puncturing | (996 + 484-tone MRU 1) | |
| | | | [1 1 x x 1 1 1 1] | 10 |
| | | | (996 + 484-tone MRU 2) | |
| | | | [1 1 1 1 x x 1 1] | 11 |
| | | | (996 + 484-tone MRU 3) | |
| | | | [1 1 1 1 1 1 x x] | 12 |
| | | | (996 + 484-tone MRU 4) | |
| 320 | MHz | No | [1 1 1 1 1 1 1 1] | 0 |
| | | puncturing | (4 × 996-tone RU 1) | |
| | | 40 MHz | [x 1 1 1 1 1 1 1] | 1 |
| | | puncturing | (3 × 996 + 484-tone MRU 1) | |
| | | | [1 x 1 1 1 1 1 1] | 2 |
| | | | (3 × 996 + 484-tone MRU 2) | |
| | | | [1 1 x 1 1 1 1 1] | 3 |
| | | | (3 × 996 + 484-tone MRU 3) | |
| | | | [1 1 1 x 1 1 1 1] | 4 |
| | | | (3 × 996 + 484-tone MRU 4) | |
| | | | [1 1 1 1 x 1 1 1] | 5 |
| | | | (3 × 996 + 484-tone MRU 5) | |
| | | | [1 1 1 1 1 x 1 1] | 6 |
| | | | (3\acute{ }996 + 484-tone MRU 6) | |
| | | | [1 1 1 1 1 1 x 1] | 7 |
| | | | (3 × 996 + 484-tone MRU 7) | |
| | | | [1 1 1 1 1 1 1 x] | 8 |
| | | | (3 × 996 + 484-tone MRU 8) | |
| | | 80 MHz | [x x 1 1 1 1 1 1] | 9 |
| | | puncturing | (3 × 996-tone MRU 1) | |
| | | | [1 1 x x 1 1 1 1] | 10 |
| | | | (3 × 996-tone MRU 2) | |
| | | | [1 1 1 1 x x 1 1] | 11 |
| | | | (3 × 996-tone MRU 3) | |
| | | | [1 1 1 1 1 1 x x] | 12 |
| | | | (3 × 996-tone MRU 4) | |
| 320 | MHz | Concur- | [x x x 1 1 1 1 1] | 13 |
| | | rent 80 | (2 × 996 + 484-tone MRU 7) | |
| | | MHz and | [x x 1 x 1 1 1 1] | 14 |
| | | 40 MHz | (2 × 996 + 484-tone MRU 8) | |
| | | puncturing | [x x 1 1 x 1 1 1] | 15 |
| | | | (2 × 996 + 484-tone MRU 9) | |
| | | | [x x 1 1 1 x 1 1] | 16 |
| | | | (2 × 996 + 484-tone MRU 10) | |
| | | | [x x 1 1 1 1 x 1] | 17 |
| | | | (2 × 996 + 484-tone MRU 11) | |
| | | | [x x 1 1 1 1 1 x] | 18 |
| | | | (2 × 996 + 484-tone MRU 12) | |
| | | | [x 1 1 1 1 1 x x] | 19 |
| | | | (2 × 996 + 484-tone MRU 1) | |
| | | | [1 x 1 1 1 1 x x] | 20 |
| | | | (2 × 996 + 484-tone MRU 2) | |
| | | | [1 1 x 1 1 1 x x] | 21 |
| | | | (2 × 996 + 484-tone MRU 3) | |
| | | | [1 1 1 x 1 1 x x] | 22 |
| | | | (2 × 996 + 484-tone MRU 4) | |
| | | | [1 1 1 1 x 1 x x] | 23 |
| | | | (2 × 996 + 484-tone MRU 5) | |
| | | | [1 1 1 1 1 x x x] | 24 |
| | | | (2 × 996 + 484-tone MRU 6) | |

The modulo operation given in Equation 1 may be differently applied to MRU in non-OFDMA PPDU. In an embodiment, the modulo operation may be applied based on the entire MRU in non-OFDMA PPDU. For example, referring to FIG. 9A, the modulo operation in Equation 1 may be applied to entire 484+242-tone MRU with a 20 MHz subchannel punctured as shown in the third and fourth row. The 484+242-tone MRU includes a 484-tone RU and a 242-tone RU, and the modulo operation is applied to the entire MRU regardless of the size of each RU included in the MRU. Accordingly, the pilot tone traveling (shift) would be limited within the entire 484+242-tone MRU.

In another embedment, the modulo operation of the Equation 1 to the MRU may be applied to each RU of the MRU. Referring to FIG. 9B, the modulo operation in Equation 1 may be applied to each RU (i.e., 242-tone RU and 484-tone RU) of the 484+242-tone MRU. The 484+242-tone MRU includes 484-tone RU and 242-tone RU, and the modulo operation is individually applied to the 484-tone RU and 242-tone RU. Accordingly, the same modulo operation as described above using Equation 1 and Table 2 may be applied in this embodiment.

In an embodiment, the SIG field of the PPDU may include indication whether or not the traveling pilot pattern is applied. For example, U-SIG field 416 or 466 in FIGS. 4A and 4B may include a control information to indicate whether the traveling pilot pattern is applied to the data field 404 or 454. As described, the traveling pilot pattern may be applied when the receiving STA is under medium to higher doppler circumstances.

On the other hand, the SIG field of the PPDU may implicitly indicate whether or not the traveling pilot pattern is applied. For example, the control information in the U-SIG field 416 or 466 may implicitly indicates the usage of the traveling pilots, when following parameter related to the LTF sequence may be set:
LTF type is set to 4×-LTF or
LTF type is set to 2×-LTF or
GI is set to 3.2 us or
GI is set to 1.6 us or
GI+LTF size field in SIG field is set to the value for 4×LTF+3.2 s or
GI+LTF size field in SIG field is set to the value for 2×LTF+1.6 s.

The EHT LTF fields 422 or 472 in the EHT PPDU 400 or 450 may include 1×LTF, 2×LTF, or 4×LTF sequence conforming to IEEE 802.11be standard. For example, the 1×LTF is equivalent to modulating every 4 subcarriers in an OFDM symbol of 12.8 s excluding GI (guard interval) and then transmitting only the first ¼ of the OFDM symbol in the time domain. The 2×LTF is equivalent to modulating every other subcarrier in an OFDM symbol of 12.8 s excluding GI (guard interval) and then transmitting only first half of the OFDM symbol in the time domain. Normally, in a PPDU with 2×LTF or 4×LTF, the pilot tone locations in the LTFs are the same as the fixed pilot tone locations in the data field.

When 1×LTF is applied, a group of subcarriers in LTFs may not contain any pilots because only ¼ subcarriers of the OFDM symbol in LTFs are transmitted while a RU in a data field 404 or 454 corresponding to the group of subcarriers contains pilots. It may cause degradation in channel estimation. In order to prevent this problem, 1×LTF may be not allowed to be used when the data field has the traveling pilots. Accordingly, when the U-SIG field 416 or 466 indicates the usage of the traveling pilots in data field, only 2×LTF or 4×LTF are allowed to be used and 1×LTF may be reserved or Validate. The ‘Validate’ means no further decoding is required for the receiving PPDU in the station.

In an embodiment, another pilot tone location for LTF field may be considered. In order to prevent the problem described above, the fixed pilot tone location for LTF field may be altered depending on the type of LTF. IEEE 802.11be standard provides that the pilot tone location in the LTF field is fixed regardless of the type of LTF such as 1×LTF, 2×LTF and 4×LTF. The location of pilot tone may change depending on the type of LTF to cover all or most tone when the traveling pilots is applied. Accordingly, the range of the limitation or confinement to the pilot pattern (within RU, MRU or entire PPDU bandwidth) may be different.

In an embodiment, when the control information in the U-SIG field 416 or 456 indicates the usage of the traveling pilots, a pilot power boosting may be applied to improve channel estimation. The value of boosting may be 3 dB or 3.5 dB.

In an embodiment, the corresponding information included in the U-SIG field 416 or 456 may be also contained in the Capabilities information element in management frames such as beacon frame, probe request/response frame, association request/response frame, re-association request/response frame.

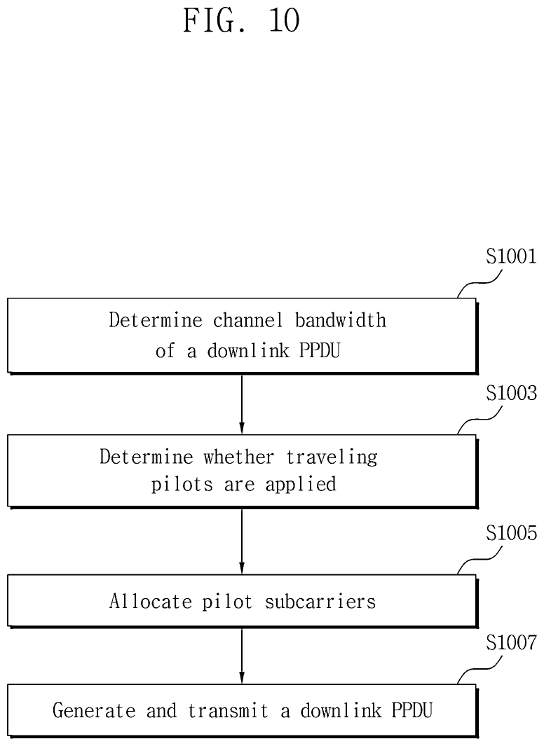

FIG. 10 shows an example of operations for facilitating transmission of a downlink PPDU by an AP STA. The example may use EHT MU PPDU or EHT TB PPDU conforming IEEE 802.11be and any future amendments to the IEEE 802.11 standard.

At S1001, the AP STA may determine a channel bandwidth of the PPDU for downlink transmission. The channel bandwidth of the PPDU may be 20 MHz, 40 MHz, 80 MHz, 160 MHz, or 320 MHz.

At S1003, the AP STA may determine whether a traveling pilot pattern is applied to the downlink PPDU. The AP STA may consider whether the receiving STA is moving at medium-high speed which may place the receiving STA in Doppler circumstance. In some implementations, the AP STA may consider channel status information which is reported or feedbacked from the receiving STA.

At S1005, the AP STA may allocate pilot subcarriers into the PPDU. The AP STA may allocate a plurality of pilots in data symbols. When the AP STA determines that the traveling pilot pattern is applied at S1003, the AP STA may allocate the traveling pilots in data symbols. As described above, the pilot tone location may be shifted from one symbol to another symbol or within a group of symbols. Further, the pilot tone location may be shifted within a single RU or MRU in OFDMA PPDU or non-OFDMA PPDU. The AP STA may allocate a plurality of pilots in LTF symbols and the location of pilots may be fixed. The LTF symbols may include 1×LTF, 2×LTF, or 4×LTF sequences.

At S1007, the AP STA generates a downlink PPDU. An example of PPDU is shown in FIGS. 4A and 4B. In particular, the U-SIG 416 or 466 may include information that explicitly or implicitly indicates whether the downlink PPDU uses the traveling pilot pattern in the data field 404 or 454. The AP STA transmits the downlink PPDU in the bandwidth determined at S1001 to a non-AP STA.

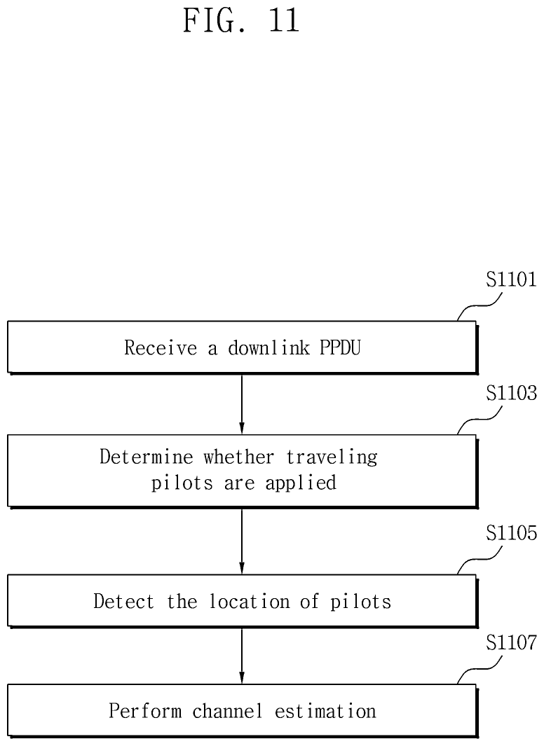

FIG. 11 shows an example of operations for facilitating reception of a downlink PPDU by a non-AP STA. The example may use EHT MU PPDU or EHT TB PPDU conforming IEEE 802.11be and any future amendments to the IEEE 802.11 standard.

At S1101, the non-AP STA may receive the downlink PPDU from the AP STA. The channel bandwidth of the downlink PPDU may be 20 MHz, 40 MHz, 80 MHz, 160 MHz, or 320 MHz.

At S1103, the non-AP STA may determine whether a traveling pilot pattern is applied to the downlink PPDU transmitted from the AP STA. In some implementation, the non-AP STA may determine whether a traveling pilot pattern is applied to the downlink PPDU based on information included in the SIG field, such as U-SIG 416 or 466, of the PPDU. The information in the SIG field may explicitly or implicitly indicate whether or not the traveling pilot pattern is applied in the data field 404 or 454.

At S1105, the non-AP STA may detect the location of pilot subcarriers in the downlink PPDU. When the traveling pilot pattern is applied, the non-AP STA may locate the traveling pilot tones in data symbols based on the pattern which may be indicated in the SIG of the PPDU. The pilot tone location may be shifted from symbol to symbol or within a group of symbols based on a predetermined pattern. Further, the pilot tone location may be shifted within a single RU or MRU in OFDMA PPDU or non-OFDMA PPDU. The non-AP STA may locate the pilot tones in LTF symbols which may be fixed. The LTF symbols may include 1×LTF, 2×LTF, or 4×LTF sequences.

At S1107, the non-AP station may perform channel estimation using the pilot tones in LTF symbols and data symbols of the PPDU.

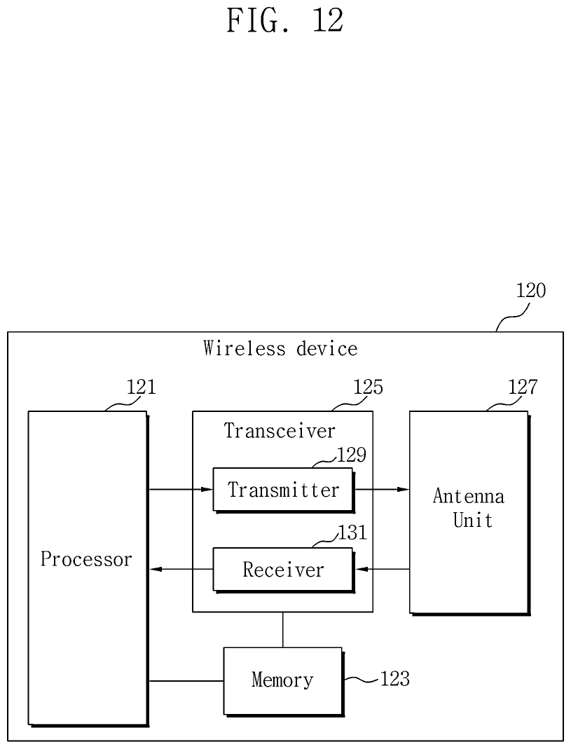

FIG. 12 shows a block diagram illustrating an example of a wireless device in accordance with an embodiment. The wireless device 120 may be, for example, an AP STA or non-AP STA. The wireless device 120 may include a processor 121, a memory 123, a transceiver 125, and an antenna unit 127. The transceiver 125 may include a transmitter 129 and a receiver 131. In various examples, the wireless device 120 may be configured to perform any one or more of the functions described herein.

The processor 121 may perform MAC functions, PHY functions, RF functions, or combination of some or all of the foregoing. That is, the processor 121 may be used to implement any one or more of the processes and procedures described herein including allocating/locating traveling pilot tones in the PPDU and performing channel estimation based on the traveling pilots. In some implementations, the processor 121 may comprise some or all of functions performed in the transmitter 129 or the receiver 131. The processor 121 may be directly or indirectly coupled to the memory 123. In some implementations, the processor 121 may include one or more processors.

The memory 123 may be non-transitory computer-readable recording medium storing instructions that, when executed by the processor 121, cause the wireless device 120 to perform operations, methods or procedures described herein. In some implementations, the memory 123 may store instructions that are needed by one or more of the processor 121, the transmitter 129, the receiver 131, and other components of the wireless device 120. The memory 123 may further store an operating system and applications. The memory 123 may comprise, be implemented as, or be included in a read-and-write memory, a read-only memory, a volatile memory, a non-volatile memory, or a combination of some or all of the foregoing.

The transceiver 125 may include the transmitter 129 and the receiver 131. The transmitter 129 may transmit and receive to and from one or more another wireless device using the antenna unit 127.

The antenna unit 127 may include one or more physical antennas. When multiple-input multiple-output (MIMO) or multi-user MIMO is used, the antenna unit 127 may include more than one physical antennas.

To illustrate the interchangeability of hardware and software, items such as the various illustrative blocks, modules, components, methods, operations, instructions, and algorithms have been described generally in terms of their functionality. Whether such functionality is implemented as hardware or software depends upon the particular application and design constraints imposed on the overall system. Skilled artisans may implement the described functionality in varying ways for each particular application.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device for facilitating wireless communication, the AP device comprising:
a processor configured to generate a physical layer protocol data unit (PPDU) including a first short training field (STF), a first long training field (LTF), a first signal (SIG) field, a repeated first signal (R-SIG) field, a second SIG field, a second STF, one or more second LTFs, and a data field, the data field including a plurality of pilot tones in a plurality symbols, wherein a group of pilot tones is shifted from symbol to symbol within a group of subcarriers during the data field; and
a transceiver coupled to the processor, the transceiver configured to transmit the PPDU to a non-AP device.

2. The AP device of claim 1, wherein the group of subcarriers is a resource unit (RU).

3. The AP device of claim 1, wherein the group of subcarriers is a multiple RU (MRU).

4. The AP device of claim 3, wherein the MRU comprises a plurality of RUs and the group of pilot tones is shifted from symbol to symbol within the entire MRU during the data field.

5. The AP device of claim 3, wherein:
the MRU comprises a plurality of RUs,
the group of pilot tones is divided into a plurality of sub-groups of pilot tones, and
each of the plurality sub-groups of pilot tones is individually shifted from symbol to symbol within a corresponding RU of the plurality of RUs during the data field.

6. The AP device of claim 1, wherein the second SIG field includes a control information indicating whether the plurality of pilot tones are shifted during the data field.

7. The AP device of claim 1, wherein the second SIG field includes a control information of a puncturing pattern indicating a punctured subchannel of operating bandwidth.

8. The AP device of claim 1, wherein the one or more second LTFs include a plurality of pilot tones which have fixed positions.

9. The AP device of claim 1, wherein the group of subcarriers has a same number of pilot tones in each of the plurality of symbols during the data field.

10. A non-access point (AP) device for facilitating wireless communication, the non-AP device comprising:
a transceiver configured to receive, from an AP device, a physical layer protocol data unit (PPDU) including a first short training field (STF), a first long training field (LTF), a first signal (SIG) field, a repeated first signal (R-SIG) field, a second SIG field, a second STF, one or more second LTFs, and a data field, the data field including a plurality of pilot tones in a plurality symbols, wherein a group of pilot tones is shifted from symbol to symbol within a group of subcarriers during the data field; and
a processor coupled to the transceiver, the processor configured to perform channel estimation using the plurality of pilot tones in the data field.

11. The non-AP device of claim 10, wherein the group of subcarriers is a resource unit (RU).

12. The non-AP device of claim 10, wherein the group of subcarriers is a multiple RU (MRU).

13. The non-AP device of claim 12, wherein the MRU comprises a plurality of RUs and the group of pilot tones is shifted within the entire MRU.

14. The non-AP device of claim 12, wherein:
the MRU comprises a plurality of RUs,
the group of pilot tones is divided into a plurality of sub-groups of pilot tones, and
each of the plurality of sub-groups of pilot tones is individually shifted from symbol to symbol within a corresponding RU among the plurality of RUs during the data field.

15. The non-AP device of claim 10, wherein the second SIG field includes a control information indicating whether the plurality of pilot tones are shifted in the data field.

16. The non-AP device of claim 10, wherein the second SIG field includes a control information of a puncturing pattern indicating a punctured subchannel of operating bandwidth.

17. The non-AP device of claim 10, wherein:
the one or more second LTFs include a plurality of pilot tones which have fixed positions, and
the processor is further configured to perform channel estimation using the plurality of pilot tones in the one or more second LTFs.

18. The non-AP device of claim 10, wherein the group of subcarriers has a same number of pilot tones in each of the plurality of symbols during the data field.

19. A method for a wireless device for facilitating a communication, the method comprising:
receiving a physical layer protocol data unit (PPDU) including a first short training field (STF), a first long training field (LTF), a first signal (SIG) field, a repeated first signal (R-SIG) field, a second SIG field, a second STF, one or more second LTFs, and a data field, the data field including a plurality of pilot tones in a plurality symbols, wherein a group of pilot tones is shifted from symbol to symbol within a group of subcarriers during the data field; and
performing channel estimation using the plurality of pilot tones in the data field.

20. The method of claim 19, wherein:
the group of subcarriers is a multiple RU (MRU),
the MRU comprises a plurality of RUs, and
the group of pilot tones is shifted from symbol to symbol within the entire MRU during the data field.
